(19) United States
(12) Patent Application Publication
(10) Pub. No.: US 2013/0345353 A1
(43) Pub. Date: Dec. 26, 2013

(54) THERMOPLASTIC MOLDING COMPOUNDS ON THE BASIS OF STYRENE COPOLYMERS AND POLYAMIDES HAVING IMPROVED LOW-TEMPERATURE TOUGHNESS

(71) Applicants: Martin Weber, Maikammer (DE); Marko Blinzler, Mannheim (DE)

(72) Inventors: Martin Weber, Maikammer (DE); Marko Blinzler, Mannheim (DE)

(73) Assignee: BASF SE, (DE)

(21) Appl. No.: 13/992,852

(22) PCT Filed: Dec. 19, 2011
(86) PCT No.: PCT/EP2011/073194

§ 371 Date: Aug. 27, 2013

(30) Foreign Application Priority Data
Dec. 20, 2010 (EP) 10195836.1

(51) Int. Cl. C08L 33/20

(52) U.S. Cl. CPC C08L 33/20
USPC 524/504; 525/77

(57) ABSTRACT

The invention relates to thermoplastic molding compounds, containing a) 3 to 91.9 wt % of one or more styrene copolymers as component A, b) 3 to 91 wt % of one or more polyamides as component B, c) 3 to 50 wt % of one or more graft natural rubbers as component C, d) 0.1 to 25 wt % of one or more compatibilizers as component D, and e) 2 to 30 wt % of ethylene-1-octene copolymer having functional groups as component E, said thermoplastic molding compounds having improved low-temperature toughness.

The present invention relates to thermoplastic molding compositions comprising styrene copolymer, polyamide, graft rubber, compatibilizer, and impact modifier, to processes for producing same, to thermoplastic molding compositions obtainable by said processes, to the use of said thermoplastic molding compositions, and also to moldings, fibers, and foils which comprise said thermoplastic molding compositions.

Polymer mixtures (“blends”) made of (methyl)styrene-acrylonitrile copolymers and of polyamides are known per se. Binary blends made of said polymer components have very poor toughness values because of the incompatibility between polyamide and, for example, styrene-acrylonitrile copolymer. Use of compatibilizers can significantly improve the toughness of the blends and also their chemicals resistance, as described by way of example in EP-A 202 214, EP-A 402 528, and EP-A 784 080. These specifications describe the mixing sequence of the polymer components and compatibilizers as in principle arbitrary during the production of the blends made of (methyl)styrene-acrylonitrile copolymers and of polyamides, and the general procedure is to introduce all of the components together into a mixing apparatus, i.e. to mix them with one another in the melt simultaneously in a single step.

Particularly suitable compatibilizers are styrene-acrylonitrile-maleic anhydride terpolymers, styrene-N-phenylmaleimide-maleic anhydride terpolymers, and methyl methacrylate-maleic anhydride copolymers. It is assumed that the amino or carboxy terminal groups of the polyamides react with the functional groups of the co- and terpolymers mentioned, whereupon copolymers are produced in situ and generate the compatibility between the styrene copolymer phase and the polyamide phase.

In some application sectors, e.g. panels and ventilation grilles in the automobile sector, the low-temperature impact strength of the products is insufficient, and further rubbers are therefore used to achieve an additional increase in toughness. Rubbers used here are in particular those which become concentrated in the polyamide phase by virtue of their functionalization.

Rubbers that are suitable in principle are generally polyethylene copolymers having α-olefins as comonomer, where these moreover have functionalization by carboxylic acid derivatives, such as maleic anhydride, or acrylic acid. Details of the impact-modification of thermoplastics are found by way of example in R. J. Gaymans “Polymer Blends, Vol. II: Performance” (John Wiley & Sons, New York, 2000). A description of suitable polyethylene copolymers is found by way of example in EP-A 1 711 560.

There is therefore a requirement for molding compositions with improved low-temperature impact strength, for use in parts subject to high stress, in particular in automobile applications.

An object on which the present invention was based was to eliminate the abovementioned disadvantages, and in particular to improve the toughness of thermoplastic molding compositions.

Accordingly, the following have been discovered: improved thermoplastic molding compositions which comprise as components:
a) from 3 to 91.9% by weight of one or more styrene copolymers as component A,
b) from 3 to 91% by weight of one or more polyamides as component B,
c) from 3 to 50% by weight of one or more graft rubbers as component C,
d) from 0.1 to 25% by weight of one or more compatibilizers as component D and
e) from 2 to 30% by weight of ethylene-1-octene copolymer having functional groups as component E,
   where each of the % by weight values is based on the total weight of components A to E, and these values give a total of 100% by weight.

The invention also relates to processes for producing same, thermoplastic molding compositions which are obtainable (or have been produced) by said processes, the use of said thermoplastic molding compositions, and also moldings, fibers, and foils which comprise said thermoplastic molding compositions.

In one preferred embodiment, the thermoplastic molding compositions comprise:
a) from 3 to 91.9% by weight of one or more styrene copolymers as component A,
b) from 3 to 91% by weight of one or more polyamides as component B,
c) from 3 to 50% by weight of one or more graft rubbers as component C,
d) from 0.1 to 25% by weight of one or more compatibilizers as component D,
e) from 2 to 30% by weight of ethylene-1-octene copolymer having functional groups as component E,
f) from 0 to 3% by weight of low-molecular-weight anhydrides as component F,
g) from 0 to 50% by weight of fibrous or particulate filler or a mixture of these as component G,
h) from 0 to 40% by weight of further additions as component H,
   where each of the % by weight values is based on the total weight of components A to H, and these values give a total of 100% by weight.

In a further embodiment, the thermoplastic molding compositions comprise:
a) from 10 to 60% by weight of one or more styrene copolymers as component A,
b) from 30 to 80% by weight of one or more polyamides as component B,
c) from 10 to 40% by weight of one or more graft rubbers as component C,
d) from 1 to 20% by weight of one or more compatibilizers as component D,
e) from 3 to 25% by weight of ethylene-1-octene copolymer having functional groups, component E,
f) from 0 to 3% by weight of low-molecular-weight anhydrides as component F,
g) from 0 to 20% by weight of fibrous or particulate filler or a mixture of these as component G,
h) from 0 to 10% by weight of further additions as component H,
   where each of the % by weight values is based on the total weight of components A to H, and these values give a total of 100% by weight.

In a particular embodiment, the thermoplastic molding compositions comprise:
a) from 12 to 50% by weight of one or more styrene copolymers as component A,
b) from 30 to 60% by weight of one or more polyamides as component B,
c) from 10 to 40% by weight of one or more graft rubbers as component C,
d) from 2 to 10% by weight of one or more compatibilizers as component D,
e) from 4 to 20% by weight of ethylene-1-octene copolymer having functional groups, component E,
f) from 0 to 3% by weight of low-molecular-weight anhydrides as component F,
g) from 0 to 20% by weight of fibrous or particulate filler or a mixture of these as component G,
h) from 0 to 10% by weight of further additions as component H,
   where each of the % by weight values is based on the total weight of components A to H, and these values give a total of 100% by weight.

The thermoplastic molding compositions often comprise a component F in an amount from 0.03 to 2% by weight, based on the total weight of components A to H.

The thermoplastic molding compositions often comprise a component H, in amounts for example from 0.2 to 10% by weight, in particular 0.4 to 10% by weight, based on the total weight of components A to H.

### Regarding Component A

The thermoplastic molding compositions of the invention comprise, as component A, from 3 to 91.9% by weight, in particular from 10 to 60% by weight, preferably from 12 to 50% by weight, of at least one styrene copolymer A, where said styrene copolymer A is preferably composed of two or more monomers from the group of styrene, acrylonitrile, α-methylstyrene, and methyl methacrylate. Particular styrene copolymers are SAN or other rubber-free styrene copolymers.

Examples of component A are familiar copolymer matrices, e.g. styrene-acrylonitrile copolymers produced via bulk polymerization or emulsion or solution polymerization. Mixtures of matrices are also suitable, for example as described in Ullmann's Encyclopedia of Industrial Chemistry (VCH-Verlag, 5th edition, 1992, pp. 633 ff.).

Another embodiment of the invention produces a molding composition which comprises one or more styrene copolymers A, where said styrene copolymer A is composed of two or three monomers from the group of styrene, acrylonitrile, and/or α-methylstyrene. It is preferable that the copolymer matrix A is produced from the components acrylonitrile and styrene and/or α-methylstyrene via bulk polymerization or in the presence of one or more solvents. Preference is given here to copolymers A with molar masses Mw of from 15 000 to 300 000 g/mol, where the molar masses can be determined, for example, via light scattering in tetrahydrofuran (GPC with UV detection).

The copolymer matrix A can by way of example comprise:
(Aₐ) polystyrene-acrylonitrile produced from, based on (Aₐ), from 60 to 85% by weight of styrene and from 15 to 40% by weight of acrylonitrile, or
(A_{b}) poly-α-methylstyrene-acrylonitrile produced from, based on (A_{b}), from 60 to 85% by weight of α-methylstyrene and from 15 to 40% by weight of acrylonitrile, or
(A_{c}) a mixture of the copolymer matrix (Aa) and of the copolymer matrix (A_{b}).

The copolymer matrix A can also be obtained via copolymerization of acrylonitrile, styrene, and α-methylstyrene.

The number-average molar mass (Mn) of the copolymer matrix A is preferably from 15 000 to 150 000 g/mol (determined by means of GPC with UV detection).

The viscosity (IV) of the copolymeric matrix A (measured to DIN 53726 at 25° C. in a 0.5% strength by weight solution in DMF) is by way of example from 50 to 120 ml/g. The copolymer matrix A can be produced via bulk polymerization or solution polymerization in, for example, toluene or ethylbenzene, by a process such as that described by way of example in Kunststoff-Handbuch [Plastics handbook] (Vieweg-Daumiller, volume V, (Polystyrene), Carl-Hanser-Verlag, Munich 1969, pages 122 ff., lines 12 ff).

### Regarding Component B

The molding composition of the invention further comprises from 3 to 91% by weight, preferably from 30 to 80% by weight, in particular from 30 to 60% by weight, of one or more polyamides B, where these can be homopolyamides, copolyamides, or a mixture thereof.

The intrinsic viscosity of the polyamides of the molding compositions of the invention is generally from 70 to 350 ml/g, preferably from 70 to 170 ml/g, determined in a 0.5% strength by weight solution in 96% strength by weight sulfuric acid at 25° C. to ISO 307.

Preference is given to semicrystalline or amorphous resins with a molecular weight (weight average) of at least 5 000, described by way of example in the following U.S. Pat. Nos. 2,071,250, 2,071,251, 2,130,523, 2,130,948, 2,241,322, 2,312,966, 2,512,606, and 3,393,210.

Examples of these are polyamides that derive from lactams having from 7 to 13 ring members, e.g. polycaprolactam, polycaprylolactam, and polylaurolactam, and also polyamides obtained via reaction of dicarboxylic acids with diamines.

Dicarboxylic acids which may be used are alkanedicarboxylic acids having 6 to 12, in particular 6 to 10, carbon atoms, and aromatic dicarboxylic acids. Acids that may be mentioned here are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine, di(4-aminophenyl)methane, di(4-aminocyclohexyl)-methane, 2,2-di(4-aminophenyl)propane, 2,2-di(4-aminocyclohexyl)propane, and 1,5-diamino-2-methylpentane.

Preferred polyamides are polyhexamethyleneadipamide, polyhexamethylenesebacamide, and polycaprolactam, and also nylon-6/6,6 copolyamides, in particular having a proportion of from 5 to 95% by weight of caprolactam units.

Other polyamides suitable as component B are obtainable from w-aminoalkylnitriles, e.g. aminocapronitrile (PA 6) and adipodinitrile with hexamethylenediamine (PA 66) via what is known as direct polymerization in the presence of water, for example as described in DE-A 10313681, EP-A 1198 491, and EP-A 922 065. Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio.

Other copolyamides which have proven particularly advantageous are semiaromatic copolyamides, such as PA 6/6T and PA 66/6T, where the triamine content of these is less than 0.5% by weight, preferably less than 0.3% by weight (see EP-A 299 444).

The processes described in EP-A 129 195 and EP-A 129 196 can be used to prepare the preferred semiaromatic copolyamides with low triamine content.

The following list, which is not comprehensive, comprises the polyamides mentioned (as component B) and other polyamides (as component B) for the purposes of the invention, and the monomers comprised.

| | |
|---|---|
| AB polymers: | |
| PA 4 | Pyrrolidone |
| PA 6 | ε-Caprolactam |
| PA 7 | Ethanolactam |
| PA 8 | Caprylolactam |
| PA 9 | 9-Aminopelargonic acid |
| PA 11 | 11-Aminoundecanoic acid |
| PA 12 | Laurolactam |
| AA/BB polymers | |
| PA 46 | Tetramethylenediamine, Adipic acid |
| PA 66 | Hexamethylenediamine, Adipic acid |
| PA 69 | Hexamethylenediamine, Azelaic acid |
| PA 610 | Hexamethylenediamine, Sebacic acid |
| PA 612 | Hexamethylenediamine, Decanedicarboxylic acid |
| PA 613 | Hexamethylenediamine, Undecanedicarboxylic acid |
| PA 1212 | 1,12-Dodecanediamine, Decanedicarboxylic acid |
| PA 1313 | 1,13-Diaminotridecane, Undecanedicarboxylic acid |
| PA 6T | Hexamethylenediamine, Terephthalic acid |
| PA 9T | Nonyldiamine/Terephthalic acid |
| PA MXD6 | m-Xylylenediamine, Adipic acid |
| PA 6I | Hexamethylenediamine, Isophthalic acid |
| PA 6-3-T | Trimethylhexamethylenediamine, Terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PA PACM 12 | Diaminodicyclohexylmethane, Laurolactam |
| PA 6I/6T/PACM | as PA 6I/6T + Diaminodicyclohexylmethane |
| PA 12/MACMI | Laurolactam, Dimethyldiaminodicyclohexylmethane, |
| | Isophthalic acid |
| PA 12/MACMT | Laurolactam, Dimethyldiaminodicyclohexylmethane, |
| | Terephthalic acid |
| PA PDA-T | Phenylenediamine, Terephthalic acid |

The thermoplastic molding compositions of the invention can comprise, as component B, one or more polyamides which have, based on the entire component B, preferably from 0.1 to 0.2% by weight of triacetonediamine (TAD) terminal groups.

This can also involve mixtures of polyamides having TAD terminal groups with polyamides having no TAD terminal groups. The important factor is that the amount present of triacetonediamine terminal groups is from 0.1 to 0.2% by weight, based on the entirety of component B. It is preferable that the amount of TAD terminal groups present is from 0.14 to 0.18% by weight, in particular from 0.15 to 0.17% by weight.

### Regarding Component C

The molding composition of the invention moreover comprises from 3 to 50% by weight, preferably 10 to 40% by weight, of one or more graft polymers C.

For the purposes of the invention, graft rubbers are core-shell rubbers which can also have a multishell structure. Preference is given to graft rubbers which have, as core, a component with Tg below (−20)° C., preferably below (−40)° C. Suitable rubbers are those based on diene, on acrylate, on siloxane, and on EPDM.

The graft shell is preferably composed of styrene and acrylonitrile, and/or of other copolymerizable monomers. The ratio of hard phase to soft phase is from 10:90 to 70:30 parts by weight.

The polymerization of the hard phase also produces subordinate amounts of ungrafted fractions. These are considered to be part of the hard phase.

It is also possible to use a mixture of various rubbers. The mixing ratio of the two different rubbers is to be from 10:90 to 90:10. As a further subclaim it should be used that there is a difference of at least 5% by weight between the rubbers used, in respect of their soft-phase content.

Said graft polymer C is preferably composed of a graft base and of at least one graft. The graft polymer C is composed by way of example of two or more monomers from the group of butadiene, styrene, acrylonitrile, α-methylstyrene, methyl methacrylate, ethyl acrylate, and/or methylacrylamide. For an explanation of the graft polymer C and its production, reference is made to the description in Ullmann's Encyclopedia of Industrial Chemistry 5th edition, VCH, 1992, pages 633 ff. It is preferable that the molding composition comprises from 10 to 40% by weight of one or more graft polymers C, where said graft polymer C is composed of a graft base made of polybutadiene (or by way of example of a butadiene-containing copolymer) and at least one graft. The graft is preferably composed of two or more monomers from the group of styrene, acrylonitrile, α-methylstyrene, ethyl acrylate, and/or methylacrylamide.

Particular rubbers C that are suitable for the purposes of the present invention are those which comprise
a diene rubber based on dienes, e.g. butadiene or isoprene,
an alkyl acrylate rubber based on alkyl esters of acrylic acid, e.g. n-butyl acrylate and 2-ethylhexyl acrylate,
an EPDM rubber based on ethylene, on propylene, and on a diene,
a silicone rubber based on polyorganosiloxanes,
   or a mixture of said rubbers or, respectively, rubber monomers.

A particularly preferred rubber C is a graft polymer made of a graft base, in particular of a crosslinked diene graft base or crosslinked alkyl acrylate graft base, and of one or more graft shells, in particular of one or more styrene graft shells, acrylonitrile graft shells, or methyl methacrylate graft shells.

Processes for producing the elastomeric polymers are known to the person skilled in the art and are described in the literature.

### Regarding Component D

The molding compositions of the invention comprise, as component D, from 0.1 to 25% by weight of at least one terpolymer based on styrene, acrylonitrile, and maleic anhydride, and also on thermoplastic polymers having polar groups. It is preferable to use polymers which comprise
C.1 a vinylaromatic monomer,
C.2 at least one monomer selected from the group of C₂-C₁₂-alkyl methacrylates, C₂-C₁₂-alkyl acrylates, methacrylonitriles, and acrylonitriles, and
C.3 α,β-unsaturated components comprising dicarboxylic anhydrides.

Vinylaromatic monomers C.1 are particularly preferably styrene. For component C.2, particular preference is given to acrylonitrile. For α,β-unsaturated components comprising dicarboxylic anhydrides and for C.3, particular preference is given to maleic anhydride. Terpolymers of the aforementioned monomers are preferably used as components C.1, C.2, and C.3. Accordingly, it is preferable to use terpolymers of styrene, acrylonitrile, and maleic anhydride. Said terpolymers make a particular contribution to improvement of mechanical properties, such as tensile strength and impact strength. The amount of maleic anhydride in the terpolymer can vary widely and is generally from 0.2 to 4% by weight mol %, preferably from 0.4 to 3% by weight, particularly preferably from 0.8 to 2.3% by weight, in component C.1. Within this range, particularly good mechanical properties are achieved in relation to tensile strength and impact strength.

The terpolymer can be produced in a manner known per se. One suitable method dissolves monomer components of the terpolymer, e.g. of the styrene, maleic anhydride, or acrylonitrile, in a suitable solvent, e.g. methyl ethyl ketone (MEK). One, or optionally more than one, chemical initiator(s) is/are added to said solution. Examples of suitable initiators are peroxides. The mixture is then polymerized for a number of hours at an elevated temperature. The solvent and the unreacted monomers are then removed in a manner known per se. The ratio of component C.1 (vinylaromatic monomer) to componente C.2, e.g. the acrylonitrile monomer, in the terpolymer is preferably from 80:20 to 50:50. In order to improve the miscibility of the terpolymer with the graft copolymer C, it is preferable to select an amount of vinylaromatic monomer C.1 which corresponds to the amount of the vinyl monomer in the styrene copolymer A. The amount of component D in the polymer blends of the invention is from 0.1 to 25% by weight, preferably from 1 to 20% by weight, particularly preferably from 2 to 10% by weight. Amounts from 3 to 7% by weight are most preferred.

The molar masses M_{w} of the copolymers of component D are generally in the range from 30 000 to 500 000 g/mol, preferably from 50 000 to 250 000 g/mol, in particular from 70 000 to 200 000 g/mol, determined by GPC, using tetrahydrofuran (THF) as eluent and polystyrene calibration.

It is also possible to use styrene-N-phenylmaleimide-maleic anhydride terpolymers. Reference may also be made to the descriptions in EP-A 0 784 080 and DE-A 100 24 935, and also to DE-A 44 07 485, description of component B in that document on pages 6 and 7.

### Regarding Component E

The thermoplastic molding compositions of the invention comprise, as component E, from 2 to 30% by weight, preferably from 3 to 25% by weight, particularly preferably from 4 to 20% by weight, of an impact modifier based on ethylene-α-olefin copolymers, where these have been subsequently functionalized. Preference is given here to use of copolymers of 50 to 70% by weight of ethylene and from 30 to 50% by weight of 1-octene, where these have been functionalized with from 0.1 to 3% by weight of ethylenically unsaturated mono- or dicarboxylic acid, or with anhydrides thereof, or with a functional derivative of such an acid.

The ethylenically unsaturated mono- or dicarboxylic acid used generally comprises C₁-C₂₀-monocarboxylic acids or C₂-C₂₀-dicarboxylic acids, or anhydrides thereof, e.g. acrylic acid, fumaric acid, maleic acid, or a mixture thereof, preferably maleic anhydride or acrylic acid, or a mixture thereof.

Functionalized ethylene/1-octene copolymers are particularly preferred as component E), and particular preference is given to compositions made of:
E₁₁) from 50 to 70% by weight, preferably from 52.5 to 60% by weight, of ethylene,
E₁₂) from 29.9 to 47% by weight, preferably from 37.3 to 48% by weight, of 1-octene,
E₁₃) from 0.1 to 3% by weight, preferably from 0.2 to 2% by weight, of an ethylenically unsaturated mono- or dicarboxylic acid, or of a functional derivative of such an acid.

The molar mass of said functionalized ethylene-α-olefin copolymers (component E) is from 10 000 to 500 000 g/mol, preferably from 15 000 to 400 000 g/mol (Mn, determined by means of GPC in 1,2,4-trichlorobenzene using PS calibration).

The melt index of the ethylene copolymers is in the range from 0.4 to 0.9 g/10 min (measured at 190° C. with 2.16 kg load).

The ethylene-α-olefin copolymers can be produced—as described in U.S. Pat. No. 5,272,236—via what are known as “single-site catalysts”. In that case, the molecular weight distribution of the ethylene-α-olefin copolymers is narrow for polyolefins, being smaller than 4, preferably smaller than 3.5. The grafting of vinyl compounds onto polyolefins is described by way of example in “Polyolefin Blends” (D. Nwabunma, T. Kyu (eds.), pp. 269-304, Wiley-Interscience, Hoboken 2007).

### Regarding Component F

The molding compositions of the invention can comprise, as further component F, at least one dicarboxylic anhydride, where this means a low-molecular-weight compound which has only one dicarboxylic anhydride group. However, it is also possible to use two or more of said compounds as component F. Dicarboxylic anhydrides in the present invention are monofunctional, and this means that they react with the polyamide chains of component B, in particular with the amino function of the corresponding compounds. The molar mass of said compound is generally smaller than 3000 g/mol, preferably smaller than 1500 g/mol.

These compounds can comprise, alongside the dicarboxylic anhydride group, further functional groups, where these can react with the terminal groups of the polyamides, but have (much) lower reactivity than the anhydride function. Examples of suitable compounds F) are C₄-C₁₀-alkyldicarboxylic anhydrides, such as succinic anhydride, glutaric anhydride, adipic anhydride. Cycloaliphatic dicarboxylic anhydrides can also be used, an example being 1,2-cyclohexanedicarboxylic anhydride. Further, it is also possible, however, to use dicarboxylic anhydrides which are ethylenically unsaturated or aromatic compounds, an example being maleic anhydride, phthalic anhydride, or trimellitic anhydride. It is preferable to use phthalic anhydride.

The proportion of component F is generally from 0 to 3% by weight, and if component F is comprised in the thermoplastic molding compositions of the invention the preferred proportion is from 0.03 to 2% by weight, based on the total weight of components A to H.

### Regarding Component G

The thermoplastic molding compositions of the invention can comprise, as component G, an amount of from 0 to 50% by weight, preferably from 0 to 20% by weight, frequently from 1 to 20% by weight, in particular from 10 to 17.5% by weight, of fillers or reinforcing material.

Suitable particulate mineral fillers G are amorphous silica, carbonates, such as magnesium carbonate (chalk), powdered quartz, mica, a very wide variety of silicates, such as clays, muscovite, biotite, suzoite, tin maletite, talc, chlorite, phlogopite, feldspar, calcium silicates, such as wollastonite, or kaolin, particularly calcined kaolin. In one particularly preferred embodiment, at least 95% by weight, preferably at least 98% by weight, of the particles in the particulate fillers used have a diameter (largest dimension), determined on the finished product, of less than 45 μm, preferably less than 40 μm, and the value known as aspect ratio for these particles is preferably in the range from 1 to 25, with preference in the range from 2 to 25, determined on the finished product, i.e. generally on an injection molding.

The particle diameter can be determined here by way of example by recording electron micrographs of thin sections of the polymer mixture and using at least 25, preferably at least 50, filler particles for the evaluation process. The particle diameters can equally be determined by way of sedimentation analysis, as in Transactions of ASAE, page 491 (1983). The proportion by weight of less than 40 μm in the fillers can also be measured by means of sieve analysis. The aspect ratio is the ratio of particle diameter to thickness (largest dimension to smallest dimension).

Particulate fillers particularly preferably used are talk, kaolin, such as calcined kaolin, or wollastonite, or a mixture made of two or all of said fillers. Among these, talc with a portion of at least 95% by weight of particles of diameter smaller than 40 μm and with an aspect ratio of from 1.5 to 25, determined in each case on the finished product is. Fibrous fillers are used as componente G, examples being carbon fibers, potassium titanate whiskers, aramid fibers, or preferably glass fibers, where at least 50% by weight of the fibrous fillers (glass fibers) have a length of more than 50 μm.

The (glass) fibers used can preferably have a diameter of up to 25 μm, particularly preferably from 5 to 13 μm. It is preferable that at least 70% by weight of the glass fibers have a length of more than 60 μm. The average length of the glass fibers in the finished molding is particularly preferably from 0.08 to 0.5 mm. The length of the glass fibers is based on a finished molding obtained by way of example by injection molding. The form in which the glass fibers here are added to the molding compositions can be a form previously cut to the appropriate length or else can be in the form of continuous-filament strands (rovings). It is also possible to use mixtures of fillers and reinforcing materials.

### Regarding Component H

The thermoplastic molding compositions of the invention can be used as component H in amounts of from 0 to 40% by weight, preferably from 0 to 20% by weight, frequently from 0.2 to 10% by weight, in particular from 0 (or if present 0.4) to 10% by weight.

Examples that may be mentioned of further additives are processing aids, stabilizers, and oxidation retarders, agents to counteract decomposition by heat and decomposition by ultraviolet light, lubricants and mold-release agents, flame retardants, dyes and pigments, and plasticizers. The proportion of these is generally from 0 to 40% by weight, preferably from 0 to 20% by weight, in particular from 0 (or if present 0.2) to 10% by weight, based on the total weight of the composition. The amounts of pigments and dyes comprised are generally from 0 to 4% by weight, preferably from 0 to 3.5% by weight, and in particular from 0 (or if present 0.5) to 3% by weight.

The pigments for coloring thermoplastics are well known, see for example R. Gächter and H. Müller, Taschenbuch der Kunststoffadditive [Plastics additives handbook] (Carl Hanser Verlag, 1983, pp. 494 to 510). A first preferred group of pigments that may be mentioned is that of white pigments, such as zinc oxide, zinc sulfide, white lead (2 PbCO₃.Pb(OH)₂), lithopones, antimony white, and titanium dioxide. Of the two most commonly used crystalline forms of titanium dioxide (rutile and anatase) it is in particular the rutile form that is used for white coloring of the molding compositions of the invention. Black pigments that can be used in the invention are iron oxide black (Fe₃O₄), spinel black (Cu(Cr, Fe)₂O₄), manganese black (a mixture made of manganese dioxide, silicon oxide and iron oxide), cobalt black, and antimony black, and also particularly preferably carbon black, which is mostly used in the form of furnace black or of gas black (in which connection see G. Benzing, Pigmente für Anstrichmittel [Pigments for paints], Expert-Verlag (1988), pp. 78ff).

It is possible in the invention to adjust to particular color shades by using inorganic chromatic pigments, such as chromium oxide green, or organic chromatic pigments, such as azo pigments and phthalocyanines. Pigments of this type are generally commercially available. It can moreover be advantageous to use the abovementioned pigments and, respectively, dyes in a mixture, e.g. carbon black with copper phthalocyanines, since color dispersion in the thermoplastic is generally facilitated.

Examples of oxidation retarders and heat stabilizers which can be added to the thermoplastic compositions of the invention are halides of metals of group I of the Periodic Table, e.g. sodium halides and lithium halides, optionally in conjunction with copper(I) halides, e.g. chlorides, bromides, and iodides. The halides, in particular of copper, can also comprise electron-rich n-ligands. An example that may be mentioned of copper complexes of this type is Cu halide complexes with, for example, triphenylphosphine. It is also possible to use zinc fluoride and zinc chloride. Other compounds that can be used are sterically hindered phenols, hydroquinones, substituted members of said group, and secondary aromatic amines, optionally in conjunction with phosphorus-containing acids and, respectively, salts of these, and mixtures of said compounds, preferably in concentrations up to 1% by weight, based on the weight of the mixture.

Examples of UV stabilizers are various substituted resorcinols, salicylates, benzotriazoles, and benzophenones, the amounts of which generally used are up to 2% by weight.

Lubricants and mold-release agents, generally added in amounts of up to 1% by weight of the thermoplastic composition, are stearic acid, stearyl alcohol, alkyl stearates and stearamides, and also esters of pentaerythritol with long-chain fatty acids. It is also possible to use stearates of calcium, of zinc, or of aluminum, and also dialkyl ketones, e.g. distearyl ketone. Furthermore, ethylene oxide-propylene oxide copolymers can also be used as lubricants and mold-release agents.

The thermoplastic molding compositions of the invention are produced by processes known per se via mixing of the components. It can be advantageous to premix individual components. It is also possible to mix the components in solution with removal of the solvent. Examples of suitable organic solvents are chlorobenzene, mixtures of chlorobenzene and methylene chloride, and mixtures of chlorobenzene and aromatic hydrocarbons, such as toluene. It is preferable to operate without chlorinated solvents. The concentration of the solvent mixtures by evaproation can by way of example be achieved in vented extruders. Any of the known methods can be used to mix the, for example, dry components A to E and optionally F to H. The mixing preferably takes place at temperatures of from 200 to 320° C. via extrusion, kneading, or roll-milling of the components together, and the components here can optionally have been isolated in advance from the solution obtained during the polymerization reaction, or from the aqueous dispersion.

The thermoplastic molding compositions of the invention can be processed by the known methods of thermoplastics processing, for example via extrusion, injection molding, calendering, blow molding, or sintering.

The molding compositions of the invention can be used to produce foils, fibers, and moldings. They can moreover particularly preferably be used to produce bodywork parts in the automobile sector, in particular to produce large-surface-area external automobile parts. The molding compositions of the invention can also be used in automobile interiors.

The invention also provides corresponding moldings, fibers, or foils, and also bodywork parts of motor vehicles.

The Examples below and patent claims illustrate the invention.

### Regarding the Test Methods

The intrinsic viscosities IV of the (methyl)styrene-acrylonitrile copolymers and compatibilizers were determined at 25° C. to DIN 53726 in 0.5% strength by weight dimethylformamide solution.

The intrinsic viscosities IV of the polyamides were determined at 25° C. to ISO 307 in 0.5% strength by weight solution in concentrated sulfuric acid (96% by weight H₂SO₄).

The average particle sizes of the graft copolymers used as rubbers were determined in the form of weight-average particle sizes by means of an analytical ultracentrifuge by the method of W. Scholtan and H. Lange (Kolloid-Z. and Z.-Polymere 250 (1972), pp. 782 to 796).

The Vicat softening point was used to determine the Vicat B heat resistance of the thermoplastic molding compositions. The Vicat softening point was determined to DIN 53 460, using a force of 49.05 N and a temperature rise of 50 K per hour, on ISO specimens.

The notched impact strength aₖ of the thermoplastic molding compositions at room temperature (RT) and at −30° C. was determined on ISO specimens to ISO 179 1eA.

Flowability MVR (MVR=Melt Volume Rate) was determined to ISO 1133 at 240° C. with 10 kg load.

The processing stability of the products was determined as follows: 50 g of material were melted at 290° C. in a capillary rheometer. The viscosity of the melt was determined at 55 s⁻¹ (hertz) after a residence time of 25 minutes. The quotient (Q) of the viscosities determined after 25 and, respectively, 5 minutes is stated.

Q=η₂₅ₘᵢₙ/η₅ₘᵢₙ

η=melt viscosity

If the value of Q is smaller than 1, degradation of the product is occurring.

Regarding the production and testing of the molding compositions

### Component A

Styrene-acrylonile copolymer having 75% by weight of styrene and 25% by weight of acrylonitrile, with intrinsic viscosity 80 ml/g (determined in 0.5% strength by weight DMF solution at 25° C.)

Component B1

Polyamide B1 used comprised a nylon-6 obtained from ε-caprolactam, with intrinsic viscosity 150 ml/g (measured at 0.5% strength by weight in 96% strength sulfuric acid), e.g. Ultramid® B 27E.

### Component C1

Graft rubber having 62% by weight of polybutadiene in the core and 38% by weight of a graft shell made of 75% by weight of styrene and 25% by weight of acrylonitrile. Average particle size about 400 nm.

### Component C2

Graft rubber having 70% by weight of polybutadiene in the core and 30% by weight of a graft shell made of 75% by weight of styrene and 25% by weight of acrylonitrile. Average particle size about 370 nm.

### Component D

Component D3 used comprised a styrene-acrylonitrile-maleic anhydride terpolymer, the constitution of which was 74.4/23.5/2.1 (% by weight), intrinsic viscosity: 66 ml/g

### Component E1

Polyolefin rubber based on an ethylene-1-octene copolymer having 56.5% by weight ethylene content, grafted with maleic acid/maleic anhydrde, characterized by an MFI value (MFI=Melt Flow Index) (190° C./2.16 kg) of 0.55 g/10 min).

### Component Ecomp1

Polyolefin rubber based on polyethylene/polypropylene, grafted with maleic acid/maleic anhydride, characterized by an MFI value (190° C./2.16 kg) of 0.57 g/10 min).

### Component Ecomp2

Polyolefin rubber based on an ethylene-1-butene copolymer, grafted with maleic acid/maleic anhydride, characterized by an MFI value (190° C./2.16 kg) of 0.85 g/10 min).

### Component F

Phthalic anhydride was used as component F.

### Component H

Irganox® PS 802 (distearyl dithiopropionate), Ciba, was used as component H.

### Regarding the Production of the Molding Compositions of the Invention

The components were mixed at a melt temperature of from 240 to 260° C. in a twin-screw extruder. The melt was passed through a water bath and pelletized. Table 1 lists the results of the tests.

TABLE 1

| | comp 1 | comp 2 | 3 | comp 4 | 5 | comp 6 |
|---|---|---|---|---|---|---|
| A | 18.8 | 14.07 | 14.07 | 14.07 | 14.07 | 14.07 |
| B1 | 41 | 40.2 | 40.2 | 40.2 | 40.2 | 40.2 |
| C1 | 35 | 32 | 32 | 32 | 25 | 25 |
| C2 | — | — | — | — | 7 | 7 |
| D | 4.88 | 4.88 | 4.88 | 4.88 | 4.88 | 4.88 |
| E1 | — | — | 8.6 | — | 8.6 | — |
| Ecomp1 | — | 8.6 | — | — | — | 8.6 |
| Ecomp2 | — | — | — | 8.6 | — | — |
| F | 0.12 | 0.05 | 0.05 | 0.05 | 0.05 | 0.05 |
| H | 0.2 | 0.2 | 0.2 | 0.2 | 0.2 | 0.2 |
| Vicat B [° C.] | 103 | 89 | 94 | 90 | 95 | 90 |
| MVR | 15.3 | 12.1 | 14.5 | 11.7 | 14.1 | 12.5 |
| [ml/10 min] | | | | | | |
| ak, RT [kJ/m²] | 62.3 | 80.0 | 81.2 | 76 | 84.4 | 81.0 |
| ak, −30° C. | 15.2 | 45.2 | 60 | 51 | 63.8 | 47.8 |
| [kJ/m²] | | | | | | |
| Q = η_{25 min}/η_{5 min} | 0.56 | 0.54 | 0.78 | 0.51 | 0.77 | 0.53 |

Particularly good results are also achieved with compositions which as well as components A, B, C, D and E also comprise a component F and/or a component H.

1. A thermoplastic molding composition which comprises the following components:
a) from 3 to 91.9% by weight of one or more styrene copolymers as component A,
b) from 3 to 91% by weight of one or more polyamides as component B,
c) from 3 to 50% by weight of one or more graft rubbers as component C,
d) from 0.1 to 25% by weight of one or more compatibilizers as component D and
e) from 2 to 30% by weight of ethylene-1-octene copolymer having functional groups as component E,
where each of the % by weight values is based on the total weight of components A to E, and these values give a total of 100% by weight.

2. The thermoplastic molding composition according to claim 1, which comprises the following components:
a) from 10 to 60% by weight of one or more styrene copolymers as component A,
b) from 30 to 80% by weight of one or more polyamides as component B,
c) from 10 to 40% by weight of one or more graft rubbers as component C,
d) from 1 to 20% by weight of one or more compatibilizers as component D,
e) from 3 to 25% by weight of ethylene-1-octene copolymer having functional groups, component E,
f) from 0 to 3% by weight of low-molecular-weight anhydrides as component F,
g) from 0 to 20% by weight of fibrous or particulate filler or a mixture of these as component G,
h) from 0 to 10% by weight of further additions as component H,
where each of the % by weight values is based on the total weight of components A to H, and these values give a total of 100% by weight.

3. The thermoplastic molding composition according to claim 1, which comprises the following components:
a) from 12 to 50% by weight of one or more styrene copolymers as component A,
b) from 30 to 60% by weight of one or more polyamides as component B,
c) from 10 to 40% by weight of one or more graft rubbers as component C,
d) from 2 to 10% by weight of one or more compatibilizers as component D,
e) from 4 to 20% by weight of ethylene-1-octene copolymer having functional groups, component E,
f) from 0 to 3% by weight of low-molecular-weight anhydrides as component F,
g) from 0 to 20% by weight of fibrous or particulate filler or a mixture of these as component G,
h) from 0 to 10% by weight of further additions as component H,
where each of the % by weight values is based on the total weight of components A to H, and these values give a total of 100% by weight.

4. The thermoplastic molding composition according to claim 1, wherein the molding composition comprises a component F in an amount from 0.03 to 2% by weight, based on the total weight of components A to H.

5. The thermoplastic molding composition according to claim 1, wherein the molding composition comprises a component H in an amount from 0.2 to 10% by weight, based on the total weight of components A to H.

6. The thermoplastic molding composition according to claim 1, which comprises from 3 to 25% by weight of ethylene-1-octene copolymer having functional groups as component E.

7. The thermoplastic molding composition according to claim 1, wherein the functionalized ethylene-1-octene copolymer (component E) comprises from 50 to 70% by weight of ethylene and from 30 to 50% by weight of 1-octene.

8. The thermoplastic molding composition according to claim 1, wherein the ethylene-1-octene copolymer (component E) comprises from 50 to 70% by weight of ethylene and from 30 to 50% by weight of 1-octene, where these have been functionalized with from 0.1 to 3% by weight of ethylenically unsaturated mono- or dicarboxylic acid, or with anhydrides thereof, or with a functional derivative of such an acid.

9. A process for producing a thermoplastic molding composition according to claim 1, which comprises mixing, kneading, or roll-milling the components and then extruding same.

10. A thermoplastic molding composition that can be produced by a process according to claim 9.

11. The use of thermoplastic molding compositions according to claim 1 for producing moldings, foils, or fibers.

12. A molding, fiber, or foil, comprising a thermoplastic molding composition according to claim 1.
